(19) United States
(12) Patent Application Publication
(10) Pub. No.: US 2011/0125667 A1
(43) Pub. Date: May 26, 2011

(54) Process Pattern Automation in Tools for Business Process Modeling

(75) Inventors: Gabor Faludi, Budapest (HU); Karthik Sarangapani, Murugeshpalya (IN); Sebastian Speck, Sandhausen (DE)

(73) Assignee: SAP AG, Walldorf (DE)

(21) Appl. No.: 12/625,198

(22) Filed: Nov. 24, 2009

(51) Int. Cl. G06Q 10/00; G06F 9/44

(52) U.S. Cl. 705/348; 717/105

(57) ABSTRACT

A modified design utility for business process provides patterns. Patterns are a more efficient manner in which a technical or non-technical user of the design utility can define a business process to create a business application. Patterns are groupings of business elements that are commonly utilized in many business processes. Selection of a pattern in the design utility can generate suggestions for additional patterns or business elements to complete the overall business process based on known commonalities where the suggestions are constrained based on the types of undefined business element associations for the pattern.

### FIELD OF THE INVENTION

Embodiments of the invention relate to a business process design tool. Specifically, the embodiments of the invention relate to a tool for using patterns to build business process based applications.

### BACKGROUND

Current modeling tools for generating applications that model business processes require the user to understand business process modeling notation or programming languages. This requires that the user have a specialized knowledge of the modeling tool, the notation or language. The design tools used to model business processes are often inaccessible to inexperienced or non-technical people.

In addition, constructing an application for a business process using a business process modeling tool is time consuming. Each step of the process must be identified and the process elements must be selected and configured. Most business processes include numerous elements including flow objects, connecting objects, and artifacts. In a modeling utility, each of these elements must be individually selected and configured to build an entire business process. Configuring each of these elements and the sub-types of these elements, can be a time intensive activity. This diminishes the productivity of the worker and makes the deployment of applications based on the business models more costly.

### BRIEF DESCRIPTION OF THE DRAWINGS

Embodiments of the invention are illustrated by way of example and not by way of limitation and the figures of the accompanying drawings in which like references indicate similar elements. It should be noted that different references to “an” or “one” embodiment in this disclosure are not necessarily to the same embodiment, and such references mean at least “one.”

FIG. 1 is a flowchart of one embodiment of the process for generating a business process application.

FIG. 2 is a diagram of one embodiment of a system providing a business process design tool including a pattern component.

FIG. 3 is a diagram of a user interface of the design utility incorporating the pattern component.

### DETAILED DESCRIPTION

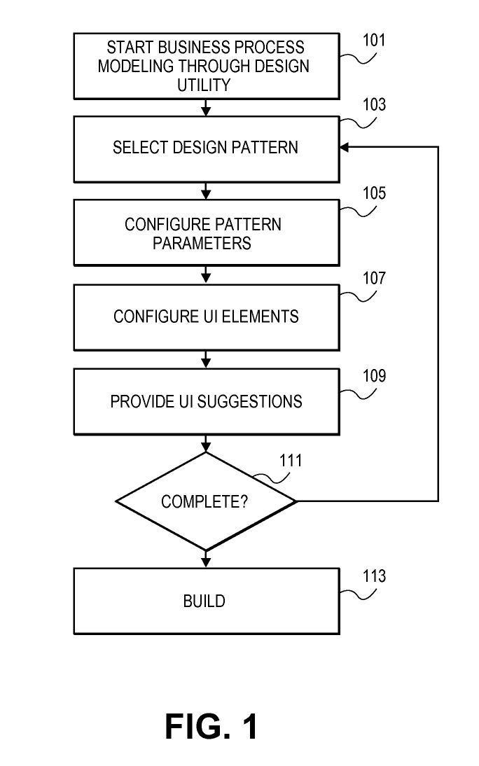

FIG. 1 is a flowchart of one embodiment of the process for generating an application from a business process. The process starts with the opening or initialization of a design utility to implement a business process that the user desires to model and create as an application (Block 101). Any design utility can be utilized for this purpose including SAP Business Process Modeling (BPM) by SAP AG of Waldorf, Germany and similar design utilities. Design utilities present the user with a page or grid upon which the elements of the process can be laid out graphically. The elements of the process can be graphically charted using Business Process Modeling Notation (BPMN). The utilities also provide the user with a user interface for selecting from the available business elements and patterns. The user can select any combination of elements and patterns. A pattern is a grouping of commonly utilized elements that correspond to a portion of a business process or a sub-process in a business process. The pattern is also presented as and conforms with BPMN.

The user starts to design the desired business process. The user selects a pattern through the design utility. The user can select, drag and drop any pattern from the user interface to the open page or similarly select a pattern for inclusion in the business process (Block 103). Upon placement of the pattern, a dialog or similar interface can be initiated through which the user configures the pattern's parameters (Block 105). The parameters of the pattern can include defining the association of the pattern including related documents, data objects and artifacts. The parameters can also include elements that define a type or variation of the pattern. The type or variation of the pattern can define the functionality of the pattern and enable a pattern to be tailored for a specific scenario. For example, an approval pattern can be defined by type parameters to specify an approval process sequence (e.g., parallel or sequential), or a condition or timing for approval such as a number or threshold of required approvers, or a random or defined approval condition (e.g., every fifth request is approved).

The configuration of the pattern can also include configuring the user interface elements associated with the pattern (Block 107). The user interface elements are to be displayed in the application being designed for the corresponding aspect of the business process. The user can configure the text, graphics, interfaces, layout, fields, windowing and similar aspects of the user interface associated with the elements of the pattern being configured. Once the user has completed the configuration of the pattern and the associated user interface elements, the dialog for this pattern can be closed.

On the design page or grid that now includes the configured pattern a set of user interface suggestions can be presented (Block 109). The user interface suggestions can be suggestions for business process elements, artifacts, other patterns or similar elements that can be linked or associated with the pattern that has just been configured. Each pattern has a specific set of associations, links or interrelations with other patterns or business elements. The user interface suggestions provide a quick way for the appropriate types of business elements and patterns to be selected. In one example, the user interface elements may be a series of buttons or activatable menus that are displayed adjacent to nodes on the pattern or similar graphical indicators. Those business elements or patterns that are suggested for each of the nodes or graphical elements are constrained to those that are appropriate for that node, link or association of the pattern. For example, if a pattern has been selected for an approval process, then the user interface suggestions can provide a set of suggestions including a review pattern, intake pattern or similar patterns commonly associated with an approval pattern.

If the user has completed the design of the business process, the user may select a build option or similar user interface option to indicate that he has completed the business process design (Block 111). This can initiate a process of building the business application or a similar process based on the model designed by the user. If the user has not completed the business process design, then the user can continue the design process by selecting another pattern or business element then placing it on the page or grid (Block 103). This process can continue until the business process design is completed. Once the business process design is completed, the user can initiate the build of the application based on the business process model (Block 113). This process is made more efficient by the use of the patterns to diminish the number of choices and the amount of knowledge that the user must have to build a business process. The use of patterns and the dialog utilized for the configuration of the patterns streamlines the process of building the business process and makes the building of the business process simpler by minimizing the number of individual business elements that must be configured and laid out for the business process modeling. The simplification decreases the number of errors and the time required to build an application for a business process.

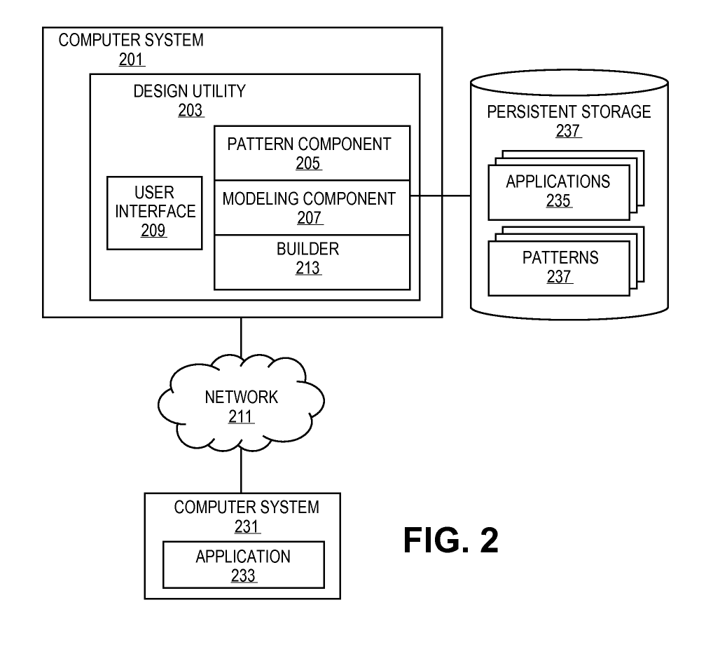

FIG. 2 is a diagram of one embodiment for a design utility incorporating a pattern component. In one embodiment, the design utility 203 is executed by a computer system 201. The computer system 201 can be any type of computer system including a desktop computer, a laptop computer, handheld computer, work station, server or similar computer system. The computer system 201 can be in communication with other computer systems 231 over a network 211 such as a local area network (LAN), wide area network (WAN), such as the Internet or similar communication system. Any portion of the design utility 203 or pattern component 205 can be distributed over this network of computer systems. Remote computer systems 231 can be any type of computer system including a desktop computer, laptop computer, handheld computer, workstation, server or similar computing system. For sake of convenience and clarity the example system in which the design utility 203 and pattern component 205 are implemented is a single computer system. However, one skilled in the art would understand that the features, structures and components of this system can be implemented as part of a distributed system.

The computer system 201 may include or be connected with a persistent storage unit 237. The persistent storage unit 237 can be any type of storage device including a fixed disc, removeable media drive, random access memory (RAM), Flash memory or similar storage structures. The persistent storage unit 237 can be used to store applications 235 including the design utility 203 and the applications created by the design utility 203. Patterns 239 created by the design utility 203 and pattern component 205 can also be stored in the persistent storage unit 237.

The design utility 203 can be any type of business modeling design utility for generating applications. Examples of the design utility 203 can include SAP BPM by SAP AG of Walldorf, Germany and similar design utilities. A design utility 203 can include a user interface component 209, modeling component 207, builder 213, a pattern component 205 and similar components. The modeling component 205 provides its functionality through a user interface 209. The functionality offered by the modeling component 207 includes the provision of all standard business elements for business processing modeling. The modeling component 207 enables a user to set forth or organize a business process on a page or grid by providing a set of business elements through a set of user interface such as menus, lists or similar user interface elements. The business elements are made available through a set of menus or similar user interface mechanisms. The business elements can be graphically manipulated as well as configured.

A pattern component 205 provides an additional set of functionality where pre-defined patterns can be utilized by the user through the user interface 209. The patterns are groupings of business elements that are provided by the modeling component 207. The pattern component 205 leverages the availability of these elements from the modeling component 207 and provides an additional user interface mechanism for the display and selection of the patterns. The patterns represent groupings of business elements for discrete portions of an overall business process. Any combination of business elements can be configured as a pattern. In many cases, those combinations that are most commonly reused and generic to many different business processes are provided by a developer. The user can select business patterns through a user interface mechanism integrated with or separate from those of the modeling component 207. The user interface mechanisms can include menus, lists, and similar user interface mechanisms. New or modified patterns can also be created by a system user or administrator. These can be presented for use with the pre-defined patterns or through a separate user interface mechanism. The pattern component 205 also provides a user interface for creating, storing and modifying patterns 239. These modified or created patterns can then be re-used and offered through the user interface 209.

Patterns are displayed graphically as icons representing groupings of business elements that are within a container representing the pattern as a whole. In addition, the pattern component 205 provides user interface elements that represent suggestions for additional business elements or patterns to be combined with a selected pattern. These user interface elements can be in the form of lists, buttons, toggles, menus or similar user interface elements. The pattern component 205 also drives the display of a dialog for the configuration a selected or placed pattern and associated user interface elements. This dialog can be presented as a set of menus, text fields or similar user interface mechanisms presented in a separate window or integrated into the design utility 203.

A builder 213 may receive a completed business process generated through the modeling component 207 and pattern component 205 and generate an application 235. The application 235 can be stored in persistent storage 237 or made available to remote computer systems 231 over network 211. These applications 235 and 233 enable performance of the business process through a series of menus, windows or similar user interface elements. These windows, menus and interface elements are generated based on the business process defined through the modeling component 207 and pattern component 205. The layout and configuration of the user interface elements and the functionality of these user interface elements can be determined by a configuration of the user when creating the business process through the modeling component 207 and pattern component 205. For example, through the user interface mechanisms of the new application can be configured through dialog of the pattern component 205, through pre-programmed functionality assigned to business elements and patterns and through similar mechanisms. The new applications can also include or use data structures for tracking and processing data. These data structures can be documents, databases and similar resources. These data structures can be identified in the configuration process or can be associated with specific patterns or business elements.

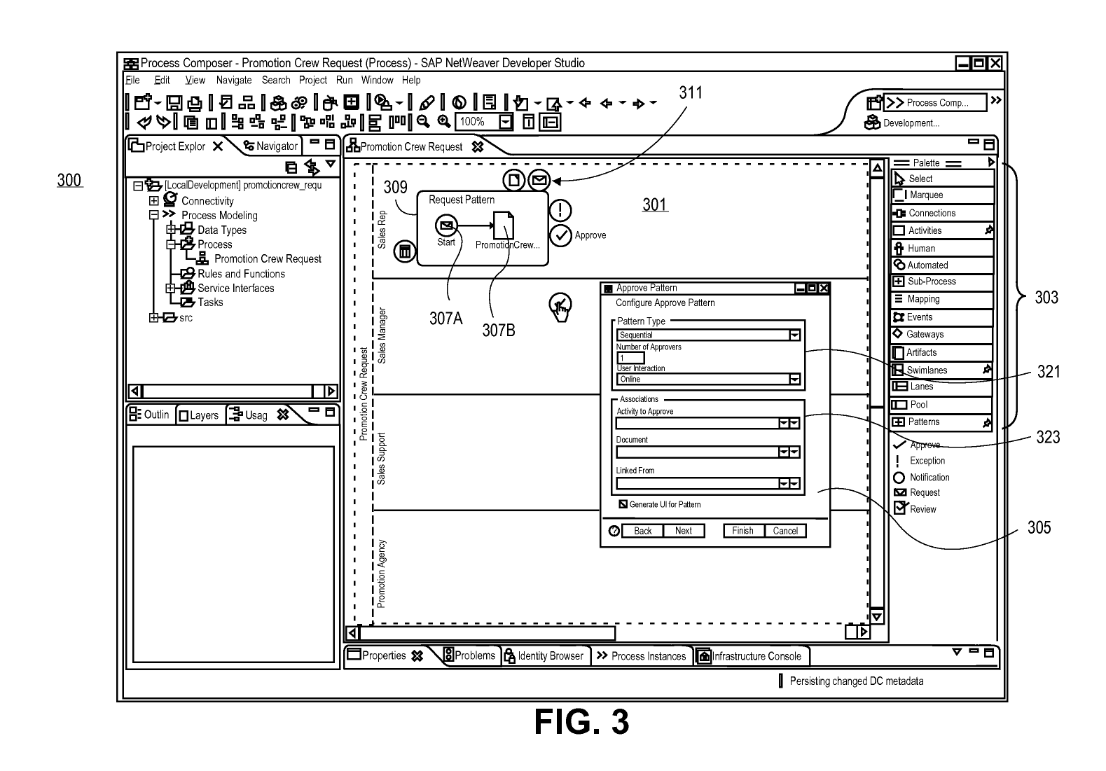

FIG. 3 is a diagram of a user interface of the design utility incorporating the pattern component. The user interface of the design utility includes a page 301 or grid that enables the user to organize business elements for the purpose of designing a business process. The range of options 303 for elements to include in the business process are set forth in a set of user interface mechanisms through which the user can select business elements and patterns. In one embodiment, these elements are selectable from a drag and drop interface such that they can be selected and moved or dragged onto the page 301 or grid. Dropping these elements on initiates a dialog 305 to configure them.

The patterns are displayed as groupings of business elements 307A, 307B within a container 309. Selection of a pattern can initiate the generation of a set of suggestion icons 311 that a user can select to quickly choose business elements or patterns that are suitable or commonly used in connection with the selected pattern. The suggested business elements or patterns are a constrained set of the available business elements or patterns that are appropriate for the undefined associations of the currently selected pattern. In the illustrated example, the user has selected an approve pattern based on the suggestion and has initiated the dialog 305 to configure the approve pattern. Once the user completes the dialog 305, the approve pattern will be displayed on the page 301 and linked to the request pattern 309.

In one embodiment, a dialog 305 allows a user to configure a pattern type 321 and a set of associations 323. As discussed above, user interface elements can also be defined through the dialog 305. The user can configure a pattern type 321, for example, an approval pattern can be configured to have an online approval interface, any number of approvers, sequential or parallel approval sequence or similar properties. The associations 323 can configure a set of documents, processes or data objects to be associated with the pattern. For example, an approval pattern can be configured for a specific activity, document, linked form or similar associations.

The page 301 and set of user interface elements 303 are a part of or integrated into a design utility 300. The other illustrated user interface elements are related to the functionality of the design utility and not described in detail for sake of clarity. One skilled in the art would understand that the functionality, features and structures of the design utility 300 can be used in combination with those described herein and that they can be provided by any combination of a modeling component, pattern component and design utility 300.

In one embodiment, the pattern component and design utility can be implemented as a set of hardware devices. In another embodiment, the system components are implemented in software (for example microcode, assembly language or higher level languages). These software implementations can be stored on a computer-readable medium. A “computer-readable” medium can include any medium that can store information. Examples of the computer-readable medium include a read only memory (ROM), a floppy diskette, a CD Rom, a DVD, a flash memory, a hard drive, an optical disc or similar medium.

In the foregoing specification, the invention has been described with references to specific embodiments. It will, however, be evident that various modifications and changes can be made thereto without departing from the broader spirit and scope that is set forth in the appended claims. The specification and drawings are accordingly to be regarded in illustrative rather than a restrictive sense.

What is claimed is:

1. A method comprising:
receiving a selection of a pattern defining a plurality of business processes to include in an application;
receiving a configuration of the pattern by a computer system; and
generating the application from the pattern.

2. The method of claim 1, further comprising:
displaying a plurality of patterns for selection through a user interface mechanism.

3. The method of claim 1, further comprising:
receiving a configuration of a user interface mechanism of the application associated with the pattern.

4. The method of claim 1, further comprising:
displaying a plurality of pattern suggestions based on the pattern, the plurality of pattern suggestions representing a plurality of patterns to be combined with the pattern.

5. The method of claim 1, wherein the pattern is displayed as a plurality of individual process elements within a container.

6. The method of claim 1, wherein configuration of the pattern comprises:
defining a pattern type or an association of the pattern with a document, data object or process.

7. The method of claim 1, further comprising:
storing a modification of the pattern or a creation of a new pattern.

8. The method of claim 1, wherein the pattern is generated in business process modeling notation.

9. A system comprising:
a design utility to provide an interface for designing an application;
a modeling component coupled to the design utility, the modeling component to provide an interface for selecting one of a plurality of business process elements; and
a pattern component coupled to the design utility, the pattern component to provide a plurality of business process element groupings as discrete configurable elements to define the application.

10. The system of claim 9, wherein the pattern component generates a plurality of pattern suggestions based on a selected pattern.

11. The system of claim 9, wherein the pattern component provides a user interface for configuring a parameter of a pattern specifying a pattern type or an association with a data object, process or document.

12. A computer readable medium having instructions stored therein, which when executed cause a machine to perform a set of operations comprising:
receiving a selection of a pattern by a computer, the pattern defining a group of process elements to include in an application;
receiving a configuration of the pattern; and
generating the application from the pattern.

13. The computer readable medium of claim 12, having further instructions stored therein, which when executed cause a machine to perform a set of operations comprising:
displaying a plurality of patterns for selection through a user interface mechanism.

14. The computer readable medium of claim 12, having further instructions stored therein, which when executed cause a machine to perform a set of operations comprising:
receiving a configuration of a user interface mechanism of the application associated with the pattern.

15. The computer readable medium of claim 12, having further instructions stored therein, which when executed cause a machine to perform a set of operations comprising:
displaying a plurality of pattern suggestions based on the pattern, the plurality of pattern suggestions representing a plurality of patterns to be combined with the pattern.

16. The computer readable medium of claim 12, wherein the pattern is displayed as a plurality of individual process elements within a container.

17. The computer readable medium of claim 12, having further instructions stored therein, which when executed cause a machine to perform a set of operations comprising:
defining a pattern type or an association of the pattern with a document, data object or process.

18. The computer readable medium of claim 12, having further instructions stored therein, which when executed cause a machine to perform a set of operations comprising:
storing a modification of the pattern or a creation of a new pattern.
